(19) United States
(12) Patent Application Publication
(10) Pub. No.: US 2008/0199748 A1
(43) Pub. Date: Aug. 21, 2008

(54) Fuel cell power generation device

(75) Inventor: Yoshihito Chida, Ichihara City (JP)

Correspondence Address: ROSSI, KIMMS & McDOWELL LLP., P.O. BOX 826, ASHBURN, VA, 20146-0826, US

(73) Assignee: Fuji Electric Holdings Co., Ltd., Kawasaki-ku (JP)

(21) Appl. No.: 12/001,478

(22) Filed: Dec. 11, 2007

(30) Foreign Application Priority Data
Dec. 11, 2006 (JP) 2006-333357

(51) Int. Cl. H01M 8/04

(52) U.S. Cl. 429/26

(57) ABSTRACT

A fuel cell power generation device prevents contamination of the cooling water of the fuel cell and maintains the pressure of the cooling water tank at the atmospheric pressure. The fuel cell power generation device includes a communicating pipe that connects the cooling water tank and the recovered water tank. The communicating pipe has a first blocking part and an open-to-atmosphere part located nearer to the cooling water tank than the first blocking part. An open-to-atmosphere device is located at a position higher than the first blocking part and couples the open-to-atmosphere part of the communicating pipe to atmospheric pressure.

### CROSS-REFERENCE TO RELATED APPLICATION

This application is based on, and claims priority from, Japanese Patent Application No. 2006-333357, filed on Dec. 11, 2006, the contents of which are incorporated herein by reference.

### BACKGROUND OF THE INVENTION

The present invention relates to a power generation system using a fuel cell, and in particular to a solid polymer fuel cell power generation system operated with a fuel cell main body (hereinafter referred to simply as a fuel cell) at temperatures approximately in the range from 60° C. to 80° C.

Normally, in a solid polymer fuel cell power generation system, a fuel cell is operated at a temperature of approximately 60° C. to 80° C. When the cooling water that circulates within the fuel cell is in a closed system, the cooling water temperature rises during power generation from a normal cool water temperature prior to operation to a high-temperature cooling water, and as a consequence, the pressure within the cooling water tank as well as the hydraulic pressure in the cooling water path rises. When the power generation device is halted, the temperature of the cooling water changes from the high temperature cooling water during power generation, to the normal cooling water temperature after the end of operation, and consequently the pressure within the cooling water tank as well as the hydraulic pressure in the cooling water path falls. Therefore, the cooling water tank and the cooling water path must have a structure capable of withstanding such pressure changes due to changes in temperature.

In the prior art, measures have been taken to provide a communicating path between the cooling water tank and a water tank (a condensed water tank) opened to the atmosphere, as a device of alleviating pressure fluctuations due to changes in temperature of the cooling water (see for example Japanese Unexamined Patent Application Publication No. 2002-141095 and corresponding U.S. Pat. No. 7,052,790). FIG. 14 shows the configuration of a solid polymer fuel cell power generation system described in U.S. Pat. No. 7,052,790. In the fuel cell 111, hydrogen in the fuel gas and oxygen in the oxidant gas are consumed by an electrochemical reaction, and water is synthesized in the oxidant gas side. The oxidant gas discharged from the fuel cell 111 is guided to the air side condenser 112, where the temperature is lowered through heat exchange with outside air; water vapor contained in the discharged air is condensed and recovered as water in the recovered water tank 113. On the other hand, exhaust fuel gas discharged from the fuel cell 111 is guided to the fuel side condenser 114, where the temperature is lowered through heat exchange with outside air, and water vapor contained in the exhaust fuel gas is condensed and recovered as water in the recovered water tank 113.

In order to maintain the fuel cell 111, which generates power at a prescribed temperature, water is circulated by a cooling water pump 116 through the cooling water path 115. In the heat exchanger 117 through which the circulating cooling water passes, heat generated in the fuel cell 111 is dissipated to the outside. When cooling water within the cooling water tank 118 decreases, water from the recovered water tank 113 is supplied to the cooling water tank 118 by operating a water supply pump 120 on a water supply path 1 19. At this time, even when an excess of water is supplied, the excess cooling water is discharged to the recovered water tank 113 through a water discharge path 121.

Further, a gas phase portion of the cooling water tank 118 is communicated, via the water discharge path 121, with a gas phase portion of the recovered water tank 113 that is open to the atmosphere. Hence, the gas in the upper portion of the cooling water tank 118 is connected via the water discharge path 121 to the recovered water tank 113 that is open to the atmosphere, so that the pressure within the cooling water tank 118 is the pressure resulting from a state of being always open to the atmosphere.

Besides the solid polymer fuel cell power generation system as described in the above-referenced patent, in which water component is recovered from the air and fuel gas discharged from the fuel cell, another system is known in the art, in which water component in the fuel gas discharged from a reformer that generates the fuel gas is also condensed and recovered. In the gas phase portion of the recovery tank that recovers the condensed water of the exhausted combustion gas in particular, plenty of exhaust combustion gas component with a high carbon dioxide concentration is contained during operation; sulfur oxides exist at the startup period of operation using city gas as a fuel gas; and soot and smoke may exist in the stopped state or at the time of malfunction depending on the combustion condition. If water containing these substances is used for the cooling water of a fuel cell, problems may arise such as increased maintenance frequency of the water treatment equipment, insulation failure due to increased electric conductivity, and deterioration of catalysis performance of the fuel cell.

In a solid polymer fuel cell power generation system described U.S. Pat. No. 7,052,790, the gas phase portion of the recovered water tank 113 and the gas phase portion of the cooling water tank are communicated through a water discharge path, so that there is a concern that the gas phase component of the recovered water tank may flow into the cooling water tank due to diffusion action or the like. In particular, after the power generation device has been stopped, the pressure within the cooling water tank and the pressure in the cooling water path drop as described above, and so a phenomenon occurs in which, due to the pressure difference, there is suction of the gas in the recovered water tank from the side of the recovered water tank at 10° C. to 40° C. to the cooling water tank. This device that a gas that decreases the purity of cooling water is introduced into the cooling water tank.

In order to avoid this situation, a check valve could be provided in the water discharge path 121. The device, however, cannot solve the problems that have been left unsolved so far; the problems include that the check valve must open at a low pressure and does not cause abnormal oscillation during temperature rise in the cooling water tank, and that the cooling water tank and connection devices must have a structure withstanding a negative pressure.

In view of the above, it would be desirable provide a fuel cell power generation device that can prevent contamination of the fuel cell cooling water and at the same time, can maintain the pressure in the cooling water tank at the atmospheric pressure.

### SUMMARY OF THE INVENTION

A fuel cell power generation device of the invention comprises a fuel cell, a cooling water tank that stores the cooling water for cooling the fuel cell, and a recovered water tank that stores water and into which a gas containing carbon dioxide inflows.

The fuel cell power generation device further comprises a communicating pipe that connects the cooling water tank and the recovered water tank. The communicating pipe has a first blocking part and an open-to-atmosphere part located nearer to the cooling water tank than the first blocking part, and an open-to-atmosphere device located at a position higher than the first blocking part that couples the open-to-atmosphere part to atmospheric pressure. The first blocking part isolates the gas phase of the cooling water tank from the gas phase of the recovered water tank, thereby preventing gas in the recovered water tank from flowing into the cooling water tank.

Further to the configuration described above, the fuel cell power generation device comprises a second blocking part that blocks gas flow through a part communicating pipe nearer to the side of the cooling water tank than the open-to-atmosphere part. Since the gas phase portion of the cooling water tank is isolated from the atmosphere by the second blocking part, any vapor in the cooling water tank is prevented from being diffused into the atmosphere.

Further to the configuration described above, the fuel cell power generation device further comprises a blocking water supply device that supplies water to the second blocking part which can be a U-shaped tube. The second blocking part is blocked by inflow of the water supplied by the blocking water supply device. Thus, the second blocking part isolates the gas phase of the cooling water tank from the atmosphere, preventing the vapor in the cooling water tank from diffusing into the atmosphere.

Further to the configuration described above, the first blocking part opens to the recovered water tank at a height lower than the minimum water level in the recovered water tank. The first blocking part is blocked by water stored in the recovered water tank. Namely, the first blocking part is located in the liquid phase portion of the recovered water tank. Thus, the gas phase in the cooling water tank is isolated from the gas phase in the recovered water tank, preventing the gas in the recovered water tank from flowing into the cooling water tank.

Further to the configuration described above, the open-to-atmosphere device is an open-to-atmosphere opening in the communicating pipe, or an open-to-atmosphere pipe that has an open-to-atmosphere opening and communicates to the communicating pipe. More specifically, the open-to-atmosphere device is an open-to-atmosphere opening in the communicating pipe, or an open-to-atmosphere pipe that has an open-to-atmosphere opening and communicates to the communicating pipe. Either of these open-to-atmosphere devices prevents the inside of the cooling water tank communicating to the communicating pipe from becoming to a negative pressure condition.

Further to the configurations described above, the length of a piping from the cooling water tank to a gas discharge part of the open-to-atmosphere device is extended in such an extent that a gas temperature discharged from the open-to-atmosphere device is 50° C. or lower. The fuel cell power generation device is continually taking in external air to ventilate the package. The highest temperature of the intake air to the fuel cell power generation device is about 40° C., and so, the upper limit temperature of the gas discharged from the open-to-atmosphere mans is set at 50° C., which is 10° C. higher than the highest temperature of the intake air to the fuel cell power generation device. The length of the piping from the cooling water tank to the gas discharge point of the open-to-atmosphere device is so adjusted that the gas temperature discharged from the open-to-atmosphere device is 50° C. or lower under the condition of the intake temperature of 40° C. adjusting the heat transfer area of the external surface of the piping that is in contact with the air in the package. The vapor that flows into the communicating pipe from the cooling water tank is allowed to discharge into the space in the fuel cell power generation device from the open-to-atmosphere device after cooled down to 50° C. or lower. By this method, the gas that flows into the communicating pipe from the cooling water tank can be discharged from the open-to-atmosphere device into the device after sufficiently reducing the contained water component, and thus, preventing the vapor in the cooling water tank from badly affecting the peripheral equipment.

Further to the configuration described above, the fuel cell power generation device further comprises a cooling device that cools at least a part of the communicating pipe from the cooling water tank to the open-to-atmosphere device. The cooling device can be fins (or some other type of mechanical heat sink device) attached on the outer surface of the communicating pipe and an air cooled fan. Even if the piping from the cooling water tank to the open-to-atmosphere device is shortened from the one described above, the water component in the vapor exhausted from the cooling water tank can be sufficiently condensed before discharging to the atmosphere.

Further to the configuration described above, the fuel cell power generation device further comprises a water-cooled cooling device that cools at least a part of the communicating pipe from the cooling water tank to the open-to-atmosphere device with the recovered water. The fuel cell power generation device comprises the branched recovered water piping that is branched from the recovered water piping for supplying the recovered water of the recovered water tank to the cooling water tank at a location in the downstream of the water treatment device; and a cooling device is provided in the branched recovered water piping to perform heat exchange between the water flowing in the branched recovered water piping and the vapor flowing in the communicating pipe. By this mechanism, the water flowing in the branched recovered water piping cools and sufficiently condenses the vapor flowing in the communicating pipe, so that the amount of vapor discharged from the open-to-atmosphere opening can be sufficiently reduced.

Another embodiment is possible in which the communicating pipe is provided with a cooling part in contact with the liquid phase of the recovered water tank at an intermediate position of the piping between the cooling water tank and the open-to-atmosphere device. The vapor flowing from the cooling water tank into the communicating pipe exchanges heat with the recovered water and cooled during flowing through the cooling part in contact with the recovered water. This embodiment, in which heat exchange is conducted with the recovered water at a temperature between 10° C. and 40° C. via the wall of the communicating pipe, performs better cooling function as compared with the first embodiment, in which heat exchange is conducted with the atmosphere in the power generation device via the wall of the communicating pipe. In addition, the temperature variation of the recovered water is less than the temperature variation of the atmosphere in the package, providing more stable cooling performance. Therefore, even when the piping from the cooling water tank to the open-to-atmosphere device is shortened in this embodiment from that in the first embodiment, the water component in the vapor exhausted from the cooling water tank is sufficiently condensed before discharged from the open-to-atmosphere device.

Further to the configurations described above, the fuel cell power generation device further comprises a discharge pipe that is connected to the communicating pipe at a position between the open-to-atmosphere device and the recovered water tank and allows the recovered water in the recovered water tank to overflow. By unifying the communicating pipe and the discharge pipe, the manufacturing process is simplified than a configuration separately connecting to the recovered water tank. The open-to-atmosphere device functions as a siphon breaker that prevents the discharge pipe from forming a siphon at the time of the recovered water tank filled with water, so that a siphon breaker that is otherwise required to connect to the discharge pipe can be omitted.

A fuel cell power generation device having the configurations described above according to the invention can alleviate the load of pressure variation due to temperature variation within the cooling water tank and the cooling water tank need not have a construction with high pressure resistance. Since the cooling water tank is opened to the atmosphere and the gas phase of the cooling water tank and the gas phase of the recovered water tank are isolated from each other with water in the communicating pipe, the gas containing impurities in the recovered water tank does not diffuse or is not drawn by suction. Therefore, the cooling water is prevented from contamination.

### BRIEF DESCRIPTION OF THE DRAWINGS

The invention will be described with reference to certain preferred embodiments thereof and the accompanying drawings, wherein:

FIG. 1 shows a fuel cell power generation device of a first embodiment example of the invention;

FIGS. 2(a), 2(b), and 2(c) show modified examples of a communicating pipe in a fuel cell power generation device of the first embodiment example of the invention;

FIG. 3 shows a modified example of a discharge pipe in a fuel cell power generation device of the first embodiment example of the invention;

FIG. 4 shows modified examples of a communicating pipe and a discharge pipe in a fuel cell power generation device of the first embodiment example of the invention;

FIG. 5 shows examples of a communicating pipe and a discharge pipe in a fuel cell power generation device of the second embodiment example of the invention;

FIG. 6 shows modified examples of a communicating pipe and a discharge pipe in a fuel cell power generation device of the second embodiment example of the invention;

FIG. 7 shows piping configuration of a communicating pipe in a fuel cell power generation device of the third embodiment example of the invention;

FIG. 8 shows piping configuration of a communicating pipe in a fuel cell power generation device of the fourth embodiment example of the invention;

FIG. 9 shows piping configuration of a communicating pipe in a fuel cell power generation device of the fifth embodiment example of the invention;

FIG. 10 shows a modified example of a communicating pipe in a fuel cell power generation device of the fifth embodiment example of the invention;

FIG. 11 shows piping configuration of a communicating pipe in a fuel cell power generation device of the sixth embodiment example of the invention;

FIG. 12 shows a modified example of a communicating pipe in a fuel cell power generation device of the sixth embodiment example of the invention;

FIG. 13 shows piping configuration of a communicating pipe in a fuel cell power generation device of the seventh embodiment example of the invention; and

FIG. 14 shows a solid polymer fuel cell power generation device of a prior art.

### DETAILED DESCRIPTION OF THE PREFERRED EMBODIMENTS OF THE INVENTION

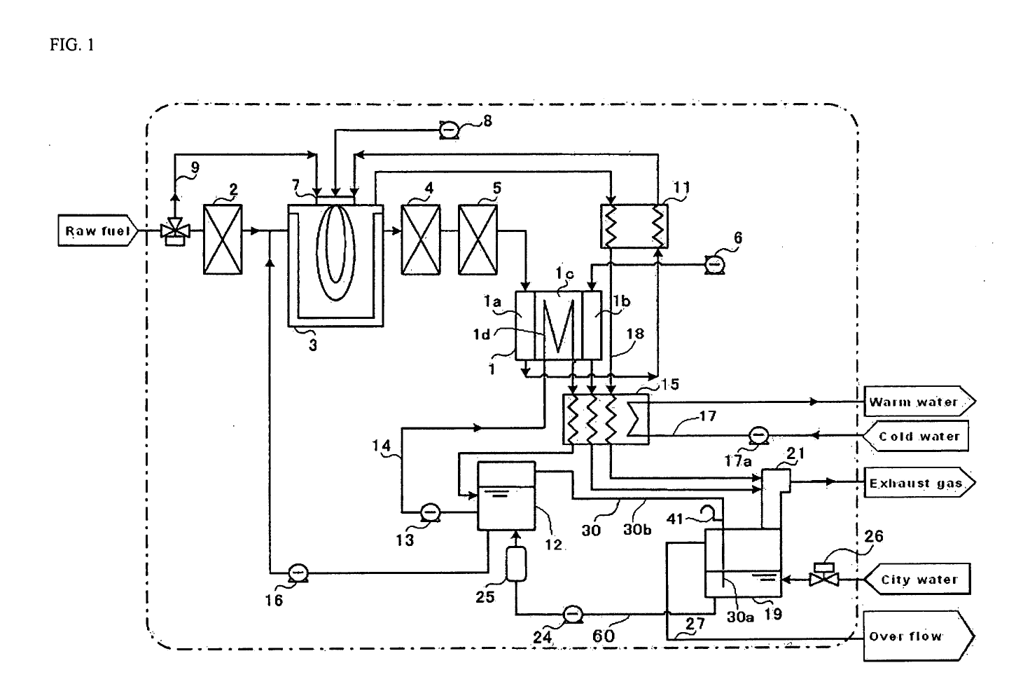

FIG. 1 shows a configuration of a fuel cell power generation device according to a first embodiment of the invention. In the fuel cell power generation device shown in FIG. 1, the main unit of a fuel cell 1 is formed by stacking unit cells, each cell comprising a fuel electrode 1a, an oxidant electrode 1b, and an electrolyte 1c sandwiched between the electrodes. A cooling plate having a cooling water path 1d is provided at every several stacked unit cells. Fuel gas is supplied to the fuel electrode 1a in the fuel cell 1, and an oxidant gas is supplied to the oxidant electrode 1b.

In the fuel gas supply system, which supplies fuel gas to the fuel electrode 1a of the fuel cell 1, a desulfurizer 2 is arranged to remove sulfur from the raw fuel; a reformer 3, which performs steam reform of the raw fuel supplied from the desulfurizer 2 to obtain the fuel gas; a CO shift converter 4, which raises the hydrogen content in the fuel gas by way of a carbon monoxide conversion reaction; and a carbon monoxide remover 5, which reduces the amount of carbon monoxide in the fuel gas through a carbon monoxide selective oxidation reaction. Oxidant gas is supplied to the oxidant electrode 1b of the fuel cell 1 by a reaction air blower 6.

Combustion air is supplied by a combustion air blower 8 to the combustor 7 of the reformer 3, and fuel for startup is raw fuel supplied via the startup fuel line 9. Reactive components contained in the exhaust gas of the fuel electrodes 1a of the fuel cell 1 are heated by the fuel preheater 11 and then supplied as fuel to the combustor 7.

Cooling water stored in the cooling water tank 12 is supplied to the cooling plate cooling water path 1d of the fuel cell 1 via the cooling water path 14 by the cooling water pump 13. High temperature cooling water that has been circulated within the fuel cell 1 passes through the exhaust heat recovery unit 15 and is cooled, and then is recovered in the cooling water tank 12. A portion of the cooling water is supplied to the reformer 3 as reforming water by the reformer water pump 16.

The user side cooling water system is directly inserted as an exhaust heat recovery system 17 into the exhaust heat recovery unit 15. The exhaust heat cooling unit 15 cools the exhaust air discharged from the oxidant electrode 1b and the combustion exhaust gas introduced via the combustion exhaust gas line 18 from the reformer 3 with the cooling water of the exhaust heat recovery system 17 through a wall, and the water component contained in these gases is condensed.

The exhaust heat recovery system 17 is supplied with cool water of the user side cooling water system by the warm water pump 17a. The exhaust heat recovery unit 15 also cools the high temperature water circulated within the fuel cell 1 and discharged. The recovery method of water component contained in the exhaust air and the combustion exhaust gas in the invention is not limited to the recovery method describe above, but can be the recovery method with the condenser of the prior art mentioned previously.

The water component condensed in the exhaust heat recovery unit 15 is stored in the recovered water tank 19 as recovered water. The water level of recovered water is monitored by a level gauge (not shown). When the recovered water is not enough and a predetermined minimum water level is reached in the recovered water tank, a replenishment water valve 26 is opened and the tank is replenished with city water. On the contrary, when the recovered water reaches a predetermined maximum water level of the recovered water tank, the excess of recovered water is discharged from the discharge line 27. A gas exhaustion part 21 is provided on the gas phase portion of the recovered water tank 19. Dry exhaust gas without a water component is discharged outside the device from the gas exhaustion part 21. The recovered water stored in the recovered water tank 19 is sent to the water treatment device 25 by the recovered water pump 24 and cleaned and then, supplied to the cooling water tank 12.

A communicating pipe 30 is provided to communicate or connect the cooling water tank 12 with the recovered water tank 19. An open-to-atmosphere device 41 is connected to the communicating pipe 30 to couple the inside of the communicating pipe to the atmosphere. In the illustrated embodiment, a first end of the communicating pipe 30 on the side of the recovered water tank 19 is inserted down to a position under the minimum level of the recovered water in the recovered water tank 19. Accordingly, the first end of the communication pipe 30 is never open to a gas phase portion of the recovered water tank 19, but instead, is located in a liquid phase portion of the recovered water tank 19. For the purposes of this discussion, the first end will be denoted as a first blocking portion 30a of the communicating pipe, as its location within the recovered water blocks any gas from being communicated between the recovered water tank 19 and the water tank 12.

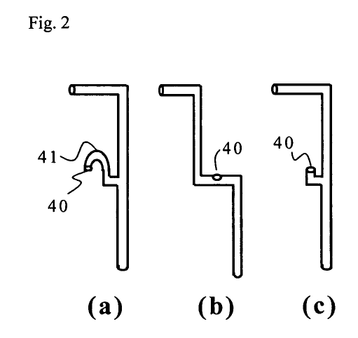

On the other hand, a second end of the communicating pipe 30 on the side of the cooling water tank 12 is open to the gas phase portion of the cooling water tank, and a piping 41, having an opening 40 open towards the direction of g as shown in FIG. 2(a), is connected to the communicating pipe 30, so that the communicating pipe 30 is open to the atmosphere along a portion defined as the open-to-atmosphere portion 30b.

Although the temperatures of the cooling water and the vapor in the cooling water tank 12 changes in the process of startup and shut down of the fuel cell power generation device, the gas phase portion of the cooling water tank 12 is open to the atmosphere through the communicating pipe 30 and the piping 41 in the fuel cell power generation device of this embodiment, eliminating pressure variation in the cooling water tank 12 due to temperature variation of the cooling water. Therefore, the load on the cooling water tank 12 and the cooling path 14 due to changes in pressure is reduced.

If the water level in the cooling water tank 12 rises to an abnormally high level, the over flowing cooling water can be recovered to the recovered water tank 19 through the communicating pipe 30. In addition, since one end of the communicating pipe 30 is open into the recovered water, which performs isolation between the gas phase in the cooling water tank 12 and the gas phase in the recovered water tank 19, there is no concern that the exhaust gas in the recovered water tank 19 will diffuse or be drawn in by suction to the cooling water tank 12 due to temperature drop in the cooling water tank 12.

The cooling water tank 12 is located at a higher position than the recovered water tank 19 in this specific embodiment. However, various arrangements are possible as long as the highest water level of the cooling water in the cooling water tank 12 (the water level at which the cooling water begins to overflow through the communicating pipe 30) is higher than the highest water level in the recovered water tank 19 (the water level at which the recovered water begins to overflow through the discharge line 27), thereby allowing the cooling water flowing into the communicating pipe 30 to be automatically recovered by gravity into the recovered water tank.

FIG. 2(a) shows the communicating pipe 30 in the embodiment of FIG. 1, and FIGS. 2(b) and 2(c) show variations from the example of FIG. 2(a). FIG. 2(b) shows a variation having an open-to-atmosphere opening 40 formed directly on the communicating pipe 30, and FIG. 2(c) shows a variation having a piping with an open-to-atmosphere opening 40 opening towards the direction reversed to the gravity direction connected to the communicating pipe 30. Although all the configurations shown in the FIGS. 2(a), 2(b), and 2(c) can bring the gas phase in the cooling water tank 12 open to the atmosphere, the configuration of FIG. 2(c) is more favorable than the configuration of FIG. 2(b) from the view point of avoiding leakage of the cooling water flown into the communicating pipe 30 out of the communicating pipe 30, and the configuration of FIG. 2(a) is more favorable than the configuration of FIG. 2(c) from the view point of preventing any contaminants such as dust from penetrating through the open-to-atmosphere opening 40. The open-to-atmosphere openings 40 are preferably provided with a dust filter (not shown).

In order to prevent the vapor that flows out of the cooling water tank 12 and is discharged into the fuel cell power generation device through the open-to-atmosphere openings 40 from badly affecting other parts, it is favorable that the water component in the vapor is thoroughly condensed within the path to the open-to-atmosphere opening 40. To accomplish this purpose in this embodiment, the piping length from the cooling water tank 12 to the open-to-atmosphere opening 40 is made long enough to cool the vapor as it flows into the communicating pipe 30 by heat dissipation and thoroughly condense the contained water component. Specific device in this embodiment is as follows.

The fuel cell power generation device is continually taking in external air to ventilate the package. The highest temperature of the intake air to the fuel cell power generation device is about 40° C., and so, the upper limit temperature of the gas discharged from the open-to-atmosphere device is set at 50° C., which is 10° C. higher than the highest temperature of the intake air to the fuel cell power generation device. The length of the piping from the cooling water tank 12 to the gas discharge point of the open-to-atmosphere device is so adjusted that the gas temperature discharged from the open-to-atmosphere device is 50° C. or lower under the condition of the intake temperature of 40° C. adjusting the heat transfer area of the external surface of the piping that is in contact with the air in the package. The vapor flowing into the communicating pipe 30 from the cooling water tank 12 is allowed to discharge into the space in the fuel cell power generation device from the open-to-atmosphere device after cooled down to 50° C. or lower.

By this method, the gas that flows into the communicating pipe 30 from the cooling water tank 12 can be discharged from the open-to-atmosphere device into the device after sufficiently reducing the contained water component, and thus, preventing the vapor in the cooling water tank from badly affecting the peripheral equipment.

The configuration of this embodiment is not limited to the ones described hereinbefore, but variations as described in the following can also be employed. For example, the discharge line 27 can be varied from the configuration with a connection to the recovered water tank 19 at the position of the maximum water level (overflow line) of the recovered water as shown in FIG. 1, to the configuration of the discharge line 50 as shown in FIG. 3, which is connected with an opening to the recovered water at a vicinity to the bottom of the recovered water tank and has an overflow line portion 50a formed by elevating the piping up to the highest level of the recovered water. In the process of discharging the recovered water through the discharge line after the water level has reached the overflow line, in order to prevent continued water discharge due to the siphon phenomenon even after the water level of the recovered water is lowered below the overflow line, the discharge line 50 is provided with the piping 51 (hereinafter also referred to as a siphon breaker) having an open-to-atmosphere opening 51a connect to the overflow line portion 50a. Using a transparent pipe in the portion rising upwards in the discharge line 50, an advantage is obtained that the water level in the recovered water tank 19 can be visually observed readily from outside.

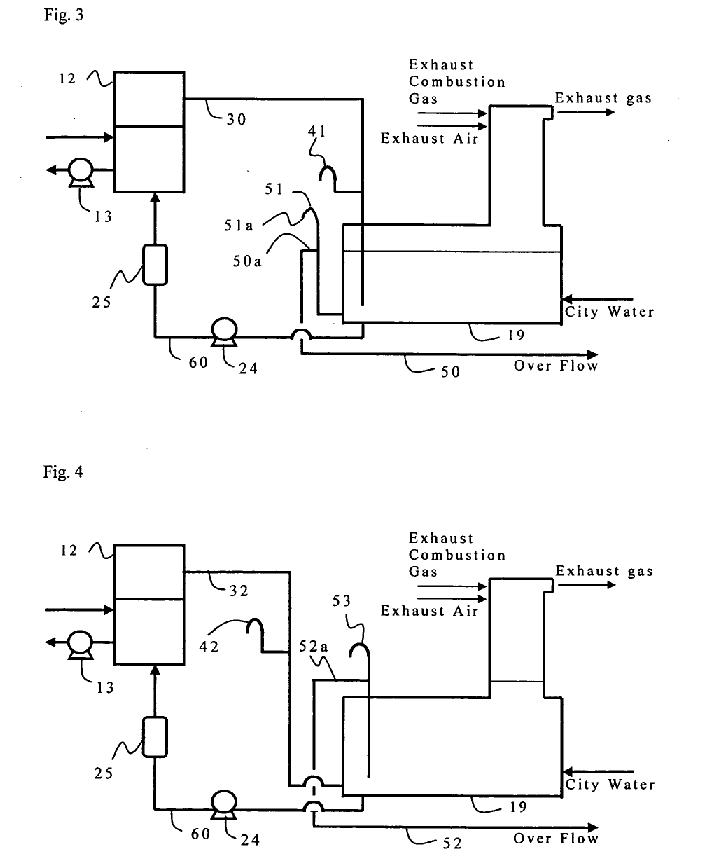

The configuration of connection of the communicating pipe 30 to the recovered water tank 19 is not limited to the one shown in FIG. 1, but the variation as shown in FIG. 4 for example, is also possible. In the variation of FIG. 4, the communicating pipe 32 having the piping 42 for opening to the atmosphere connected thereto is connected to the side face of the recovered water tank 19 and is open to the recovered water. The discharge line 52 is also possible that has the overflow line portion 52a and the siphon breaker 53 as shown in FIG. 4.

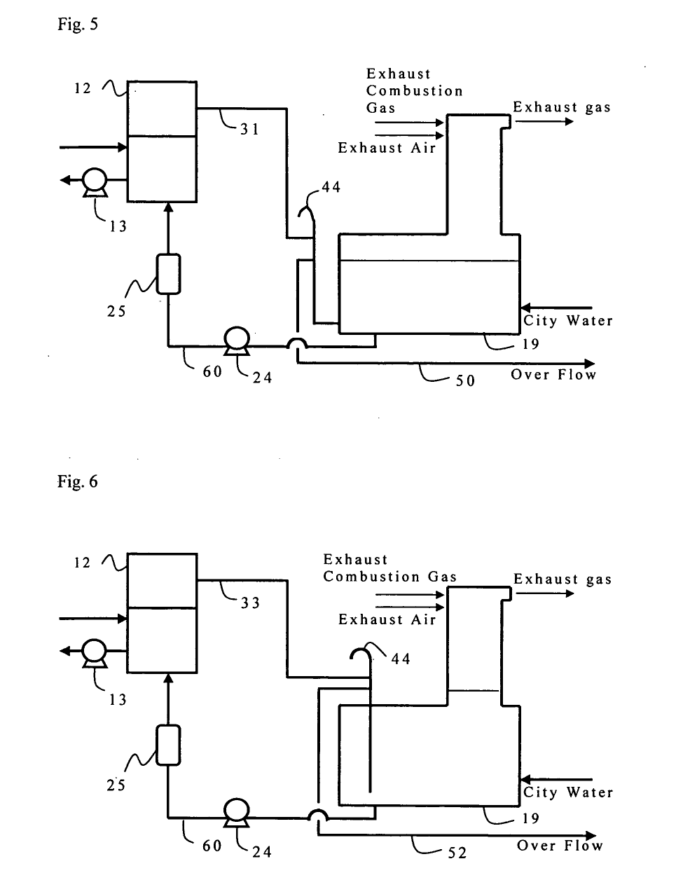

Next, a second embodiment example according to the invention will be described with reference to FIG. 5 and FIG. 6. The same configuration as that in FIG. 1 is omitted in FIGS. 5 and 6.

As shown in FIG. 5, a fuel cell power generation device of the second embodiment is provided with the discharge line 50 and the open-to-atmosphere device 44 (simultaneously serving as a siphon breaker), the both being similar to those shown in FIG. 3; the communicating pipe 31 is featured by connection to the open-to-atmosphere device 44.

Alternatively, as shown in FIG. 6, in a fuel cell power generation device comprising the discharge line 52 similar to the one shown in FIG. 4 and an open-to-atmosphere device 44 (simultaneously serving as a siphon breaker), the communicating pipe 33 can be connected to the open-to-atmosphere device 44. The end of the communicating pipe on the side of the recovered water tank 19 is opened at a level below the minimum water level of the recovered water.

In the configuration of this embodiment, the gas phase in the cooling water tank 12 is opened to the atmosphere through the open-to-atmosphere opening formed at the open-to-atmosphere device 44 and maintained at the atmospheric pressure, and at the same time, isolated from the gas phase in the recovered water tank 19 by the recovered water penetrated in the communicating pipe 31 or 33. Therefore, there is no concern of contamination due to diffusion of the gas in the recovered water tank 19 into the cooling water tank 12.

On the other hand, the cooling water flow out of the cooling water tank 12 flows into the recovered water tank until the water level in the recovered water tank 19 reaches the maximum water level. When the water level in the recovered water tank 19 reaches the maximum water level, the water is discharged through the discharge line 50 or 52 to the outside of the power generation device. Thus, water leakage into the device is avoided even if the water level contained in the cooling water tank 12 is raised.

A dust filter can be provided at the open-to-atmosphere opening of the open-to-atmosphere device 44 (simultaneously serving as a siphon breaker) as in the first embodiment. Its arrangement location is preferably at such a position that the water component in the discharged vapor is sufficiently condensed as in the first embodiment.

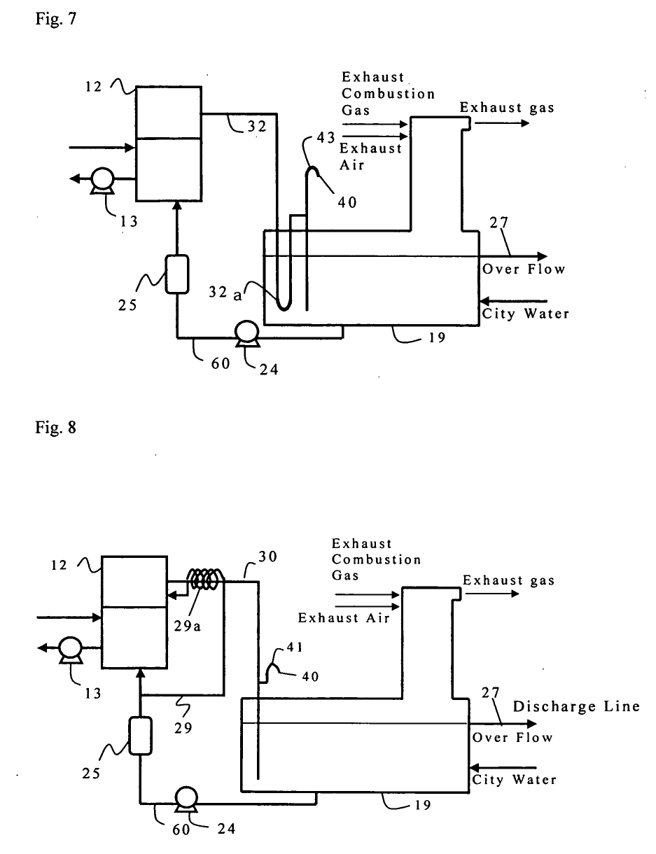

Next, the third embodiment example of the invention will be described with reference to FIG. 7, in which the same configuration as in FIG. 1 is omitted.

This embodiment example is featured by provision of the cooling device 32a to cool the piping for the vapor flowing through the communicating pipe 32 from the cooling water tank 12 to the open-to-atmosphere opening 40. Specifically, the communicating pipe 32 runs within the recovered water in the recovered water tank, and then branches and connects to the open-to-atmosphere device 43 having the open-to-atmosphere opening 40, and the end of the communicating pipe 32 on the side of the recovered water tank 19 is opened at a level lower than the minimum water level of the recovered water tank 19. The vapor flowing into the communicating pipe 32 from the cooling water tank 12 flows in the second blocking part 32a drawn into the recovered water, and cooled there by heat exchange with the recovered water. The condensed water resides in the second blocking part 32a and performs isolation function between the gas phase in the cooling water tank and the atmosphere. The temperature of the recovered water in the recovered water tank 19 is between about 10° C. and 40° C. In the case of a high temperature in the package, this embodiment performs better cooling by heat exchange with the water at the second blocking part 32a than the first embodiment example in which the vapor flowing in the communicating pipe 32 is cooled by heat dissipation to the atmosphere through the external wall of the communicating pipe 32. Since the temperature variation of the recovered water is smaller than the variation of the atmospheric temperature in the package, stable cooling performance can be obtained by this embodiment. Consequently, even when the piping from the cooling water tank 12 to the open-to-atmosphere opening 40 is shortened in this embodiment from that in the first embodiment example, the water component in the vapor exhausted from the cooling water tank 12 is sufficiently condensed in the path to the open-to-atmosphere opening 40 before discharging to the atmosphere, yet in the case of high temperature in the package. The water residing in the second blocking part 32a performs isolation function between the gas phase in the cooling water tank and the atmosphere. The supply of water to the second blocking part by a blocking water supplying device can be understood in this embodiment as follows. In order to reside water at the second blocking part 32a, a recovered water pump 24 is operated and the recovered water is deionized with the water treatment device 25 provided in the recovered water piping 60, and then water is supplied to the cooling water tank 12 to make the water over flowing from the cooling water tank to flow into the second blocking part 32a.

Next, a fourth embodiment of the invention will be described with reference to FIG. 8, in which the same configuration as in FIG. 1 is omitted. In this embodiment, similar to the third embodiment, is featured by provision of the cooling mechanism to cool at least a part of the piping in which the vapor flown into the communicating pipe 30 from the cooling water tank 12 flows until the vapor is discharged from the open-to-atmosphere opening 40 at the tip of the open-to-atmosphere device 41.

The recovered water from the recovered water tank 19 is purified in the water treatment device 25 provided in the intermediate of the recovered water piping 60 and then supplied to the cooling water tank 12. In this embodiment, the cooling device 29a is provided in the branched recovered water piping 29 that is branched from the recovered water piping 60 between the water treatment device 25 and the cooling water tank; and the cooling device performs heat exchange between the water flowing in the branched recovered water piping 29 and the vapor flowing in the communicating pipe 30.

By this device, the recovered water flowing in the branched recovered water piping 29 cools and sufficiently condenses the water component in the vapor flowing in the communicating pipe 30, so that the amount of vapor discharged from the open-to-atmosphere opening 40 is reduced sufficiently.

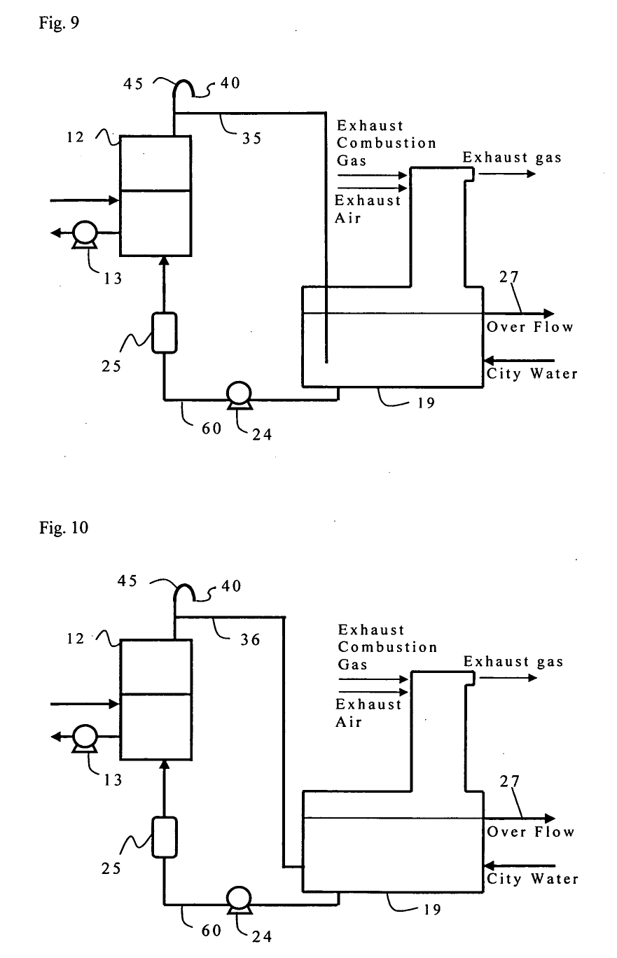

Next, a fifth embodiment according to the invention will be described with reference to FIG. 9. The same configuration as the one shown in FIG. 1 is omitted in FIG. 9. In this embodiment, the end of the communicating pipe 35 on the side of cooling water tank is connected to the upper face of the gas phase portion of the cooling water tank 12. The open-to-atmosphere piping 45 having an open-to-atmosphere opening 40 is connected to the upper face of the gas phase portion of the cooling water tank 12 through a straight line portion, from which the communicating pipe 35 is branched, and the end thereof on the side of the recovered water tank is inserted into the recovered water in the recovered water tank 19.

In this configuration, the cooling water tank 12 is opened to the atmosphere, so that the gas phase in the cooling water tank 12 is maintained at the atmospheric pressure. If the cooling water is going to overflow out of the cooling water tank 12 due to abnormal water level in the cooling water tank 12, the cooling water flows through the communicating pipe 35 to the recovered water tank 19, so that the fuel cell power generation device is prevented from water leakage.

In the communicating pipe 35 shown in FIG. 9, the end on the side of the recovered water tank 19 can be connected to the side wall at the position lower than the minimum water level of the recovered water tank 19 as the communicating pipe 36 shown in FIG. 10. Further, in place of the discharge line 27 in FIG. 9, any discharge structure for the recovered water shown in FIG. 3 and FIG. 4 can be selected, combining the discharge line 50 and the siphon breaker 51, or the discharge line 52 and the siphon breaker 53.

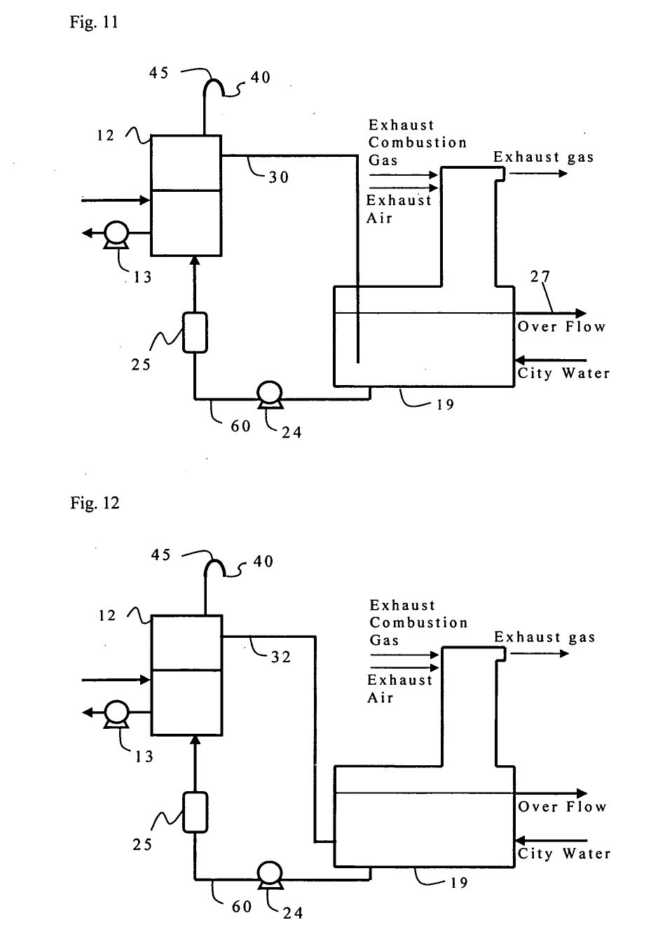

Next, a sixth embodiment example of the invention will be described with referenced to FIG. 11. The same configuration as the one shown in FIG. 1 is omitted in FIG. 11. In this embodiment too, like in the fifth embodiment, the open-to-atmosphere piping 45 having the open-to-atmosphere opening 40 is connected to the gas phase portion of the cooling water tank 12. In the communicating pipe 30, on the other hand, one end thereof is connected to the gas phase portion of the cooling water tank 12 and the other end is inserted into the recovered water in the recovered water tank.

In this configuration, the cooling water tank 12 is opened to the atmosphere, so that the gas phase in the cooling water tank 12 is maintained at the atmospheric pressure If the cooling water is going to overflow out of the cooling water tank 12 due to abnormal water level in the cooling water tank 12, the cooling water flows through the communicating pipe 30 to the recovery water tank 19, so that the fuel cell power generation device is prevented from water leakage.

In the communicating pipe 30 shown in FIG. 11, the end on the side of the recovered water tank 19 can be connected to the side wall of the recovered water tank 19 and is opening into the recovered water tank as the communicating pipe 32 shown in FIG. 12. Further, in place of the discharge line 27 shown in FIG. 11, any discharge structure for the recovered water shown in FIG. 3 and FIG. 4 can be selected, combining the discharge line 50 and the siphon breaker 51, or the discharge line 52 and the siphon breaker 53.

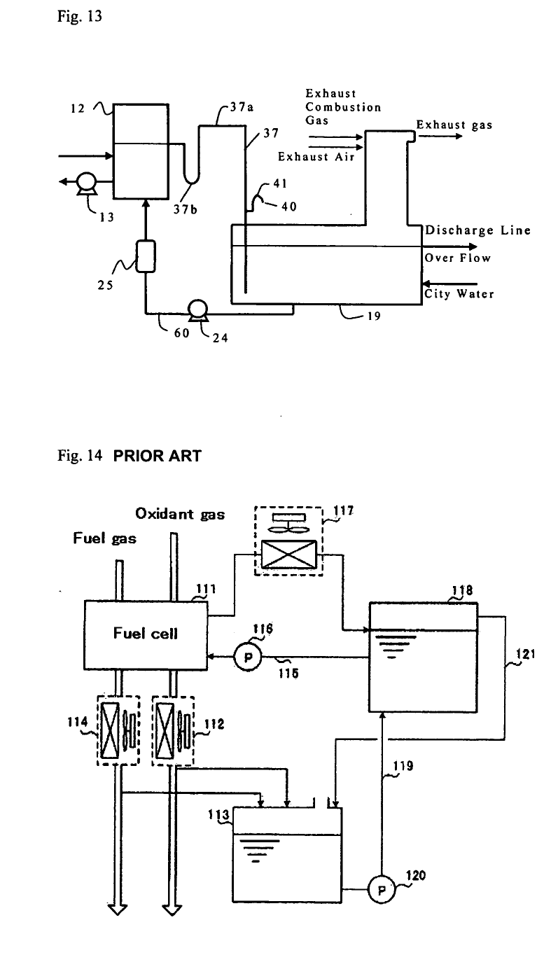

Next, a seventh embodiment of the invention will be described with reference to FIG. 13. The same configuration as the one shown in FIG. 1 is omitted in FIG. 13. A feature of this embodiment is that the communicating pipe 37 communicates the liquid phase in the cooling water tank 12 and the liquid phase in the recovered water tank. The communicating pipe 37 has the cooling water overflow line portion 37a that is elevated to the height equal to the highest water level in the cooling water tank 12 (which is the water level to overflow the cooling water), and the second blocking part 37b formed at a position lower than the highest water level in the cooling water tank 12. On the communicating pipe 37, the open-to-atmosphere device 41 having the open-to-atmosphere opening 40 is connected. In the second blocking part 37b, water that is over flowing from the cooling water tank 12 resides. The wording “to supply water to the second blocking part by a blocking water supplying device” can be understood in this embodiment as follows. In order to reside water at the second blocking part 37b when no water is present in the second blocking part 37b, a recovered water pump 24 is operated and the recovered water is deionized with the water treatment device 25 provided in the recovered water piping 60, and then water is supplied to the cooling water tank 12 to make the water over flowing from the cooling water tank to flow into the second blocking part 37b.

In this configuration, the gas phase in the cooling water tank 12 is normally isolated from the open-to-atmosphere opening 40 by the cooling water penetrated into the second blocking part 37b in the communicating pipe 37, so that the vapor in the cooling water tank 12 is inhibited to be discharged into the package, avoiding bad effects on the other equipment due to the vapor. If the level of the cooling water in the cooling water tank rises to the height of the cooling water overflow line portion 37a by accident, the cooling water flows into the communicating pipe 37 and is recovered to the recovered water tank 19. If the pressure of the gas phase in the cooling water tank 12 rises due to temperature rise or any accident and pushes down the cooling water level to the bottom level of the second blocking part 37b, the gas flowing into the communicating pipe 37 is open to the atmosphere through the open-to-atmosphere opening 40 in the piping 41. Consequently, if the pressure in the cooling water tank 12 becomes high pressure due to any accident, the gas phase in the cooling water tank 12 communicates to the open-to-atmosphere opening 40, avoiding further pressure rise.

The invention has been described with reference to certain preferred embodiments thereof. It will be understood that modifications and variations are possible within the scope of the appended claims. For example, the embodiment of FIG. 13 is illustrated with the end of the communicating pipe 37 attached to the water tank 12 to maintain the water level within the water tank 12 at a desired level, but the end of the communicating pipe 37 may be coupled to the gas phase portion of the water tank 12 as in the other embodiments while still locating the second blocking portion 37b as illustrated. Further, it will be understood that the term “gas phase portion” of the water tank 12 refers to a normal operating condition, as the communicating pipe is used as an overflow device in all of the embodiments and, as such, would communicate with the liquid phase portion of the water tank 12 when functioning as an overflow device.

What is claimed is:

1. A fuel cell power generation device that includes a fuel cell, a cooling water tank that stores cooling water for cooling the fuel cell, and a recovered water tank that stores recovered water, the fuel cell power generation device comprising:
a communicating pipe connecting the cooling water tank and the recovered water tank, wherein the communicating pipe includes a first blocking part and an open-to-atmosphere part located nearer to the cooling water tank than the first blocking part; and
an open-to-atmosphere device located at a position higher than the first blocking part that couples the open-to-atmosphere part of the communicating pipe to atmospheric pressure.

2. The fuel cell power generation device according to claim 1, further comprising a second blocking part that blocks a part of the communicating pipe and located nearer to the cooling water tank than the open-to-atmosphere device.

3. The fuel cell power generation device according to claim 1 wherein the first blocking part is located in a liquid phase portion of the recovered water tank.

4. The fuel cell power generation device according to claim 1 wherein the open-to-atmosphere device is an open-to-atmosphere opening formed on the communicating pipe.

5. The fuel cell power generation device according to claim 1 wherein the open-to-atmosphere device comprises an open-to-atmosphere pipe that has an open-to-atmosphere opening.

6. The fuel cell power generation device according to claim 1 wherein the length of the communicating pipe from the cooling water tank is extended such that a gas temperature of a gas discharged from the open-to-atmosphere device is 50° C. or lower.

7. The fuel cell power generation device according to claim 1 further comprising a cooling device that cools at least a part of the communicating pipe from the cooling water tank to the open-to-atmosphere device.

8. The fuel cell power generation device according to claim 7 wherein the cooling device is a water-cooled cooling device.

9. The fuel cell power generation device according to claim 1 further comprising an overflow discharge pipe that is connected to the recovered water tank, wherein the overflow discharge pipe maintains the recovered water in the recovered water tank at a position below the open-to-atmosphere device.

10. The fuel cell power generation device according to claim 1, wherein the water tank is located at a position higher than the recovered water tank.

11. The fuel cell power generation device according to claim 2, further comprising a water supply device that supplies water to the second blocking part.

12. The fuel cell power generation device according to claim 9, wherein a siphon breaker is coupled to the overflow discharge pipe.

13. The fuel cell power generation device according to claim 9, wherein a portion of the overflow discharge pipe is transparent.

14. The fuel cell power generation device according to claim 1, wherein the communicating pipe is connected to the water tank at a position that is higher than the highest water level maintained in the recovered water tank.

15. A fuel cell power generation device comprising:
a cooling water tank that stores cooling water for cooling a fuel cell;
a recovered water tank that stores recovered water from the fuel cell;
a communicating pipe connecting the cooling water tank and the recovered water tank, wherein a first end of the communicating pipe is connected to a gas phase portion of the water tank and a second end of the communication pipe is connected to a liquid phase portion of the recovered water tank; and
an open-to-atmosphere device located between the first end and the second end that couples an open-to-atmosphere portion of the communicating pipe to atmospheric pressure.
